(19) United States
(12) Patent Application Publication
(10) Pub. No.: US 2025/0266657 A1
(43) Pub. Date: Aug. 21, 2025

(54) MULTICORE PUMP SYSTEM FOR OPTICAL AMPLIFIERS

(71) Applicant: Lumentum Operations LLC, San Jose, CA (US)

(72) Inventors: Josh P. KEMP, Ottawa (CA); Brian SMITH, Ottawa (CA)

(21) Appl. No.: 18/647,752

(22) Filed: Apr. 26, 2024

Related U.S. Application Data
(60) Provisional application No. 63/553,729, filed on Feb. 15, 2024.

(51) Int. Cl. H01S 3/094; H01S 3/067; H01S 3/10

(52) U.S. Cl. CPC H01S 3/094069; H01S 3/06716; H01S 3/06737; H01S 3/094007; H01S 3/094065; H01S 3/1001

(57) ABSTRACT

In some implementations, an optical amplifier system includes a pump system including a pump laser source configured to output multimode pump light at a first wavelength, and a multicore fiber laser having an input end optically coupled to the pump laser source and an output end. The multicore fiber laser may include a multicore active fiber having multiple cores to convert the multimode pump light to multiple single-mode pump light outputs at one or more second wavelengths, where the multiple cores have respective laser cavities defined by fiber gratings on each of the multiple cores. The optical amplifier system may include a fiber amplifier, optically coupled to the pump system, including multiple amplifier components, in one or more active fibers, that are to be pumped by respective cores, of the multiple cores, of the multicore active fiber.

### CROSS-REFERENCE TO RELATED APPLICATION

This Patent Application claims priority to U.S. Provisional Patent Application No. 63/553,729, filed on Feb. 15, 2024, and entitled “MULTI-CORE O-BAND AMPLIFIER.” The disclosure of the prior Application is considered part of and is incorporated by reference into this Patent Application.

### TECHNICAL FIELD

The present disclosure relates generally to optical amplifiers and to a multicore pump system for optical amplifiers.

### BACKGROUND

An optical amplifier is a device that is to receive signal light and generate amplified signal light (i.e., signal light with comparatively higher optical power). Typically, the optical amplifier provides optical amplification using a so-called gain medium, which is “pumped” (i.e., provided with energy) by a source, such as a pump laser. In some cases, the optical amplifier may utilize an optical fiber as a gain medium (such a device may be referred to as a fiber amplifier). In such a case, the gain medium may be a glass fiber doped with rare earth ions, such as erbium, neodymium, ytterbium, praseodymium, thulium, or the like. Such a fiber may be referred to as an active fiber. In operation, the signal light propagates through the active fiber together with pump light, and the active fiber outputs the amplified signal light that is generated from the signal light and the pump light.

### SUMMARY

In some implementations, an optical system includes a pump system including a pump laser source configured to output multimode pump light at a first wavelength, and a multicore fiber laser having an input end optically coupled to the pump laser source and an output end. The multicore fiber laser may include a multicore active fiber having multiple cores to convert the multimode pump light to multiple single-mode pump light outputs at one or more second wavelengths, where the multiple cores have respective laser cavities defined by fiber gratings on each of the multiple cores. The optical system may include a signal combiner, optically coupled to the output end of the multicore fiber laser, configured to combine the single-mode pump light outputs with signal light. The optical system may include a fiber amplifier, optically coupled to an output of the signal combiner, including multiple amplifier components, in one or more active fibers, that are to be pumped by respective cores, of the multiple cores, of the multicore active fiber.

In some implementations, a pump system includes a pump laser source configured to output multimode pump light at a first wavelength, and a multicore fiber laser having an input end optically coupled to the pump laser source and an output end. The multicore fiber laser may include a multicore active fiber having multiple cores to convert the multimode pump light to multiple single-mode pump light outputs at one or more second wavelengths, where the multiple cores have respective laser cavities defined by fiber gratings on each of the multiple cores.

In some implementations, an optical amplifier system includes a pump system including a pump laser source configured to output multimode pump light at a first wavelength, and a multicore fiber laser having an input end optically coupled to the pump laser source and an output end. The multicore fiber laser may include a multicore active fiber having multiple cores to convert the multimode pump light to multiple single-mode pump light outputs at one or more second wavelengths, where the multiple cores have respective laser cavities defined by fiber gratings on each of the multiple cores. The optical amplifier system may include a fiber amplifier, optically coupled to the pump system, including multiple amplifier components, in one or more active fibers, that are to be pumped by respective cores, of the multiple cores, of the multicore active fiber.

### BRIEF DESCRIPTION OF THE DRAWINGS

FIG. 1 is a diagram of an example optical system.

FIG. 2 is a diagram of an example optical system.

FIG. 3 is a diagram of an example plot showing a relationship between laser power and amplifier rail count.

### DETAILED DESCRIPTION

The following detailed description of example implementations refers to the accompanying drawings. The same reference numbers in different drawings may identify the same or similar elements.

Fiber amplifiers are used in optical communication systems to increase the strength of optical signals, thereby enabling long-distance transmission. Some fiber amplifiers provide Original band (O-band) amplification. O-band amplifiers are desirable for their ability to amplify over a large amount of spectrum and for their applications in datacenter transmission.

A fiber amplifier may be pumped optically using one or more optical pump sources, such as one or more laser diodes. In general, a single fiber amplifier is pumped using a single pump laser source. Accordingly, multi-rail amplifiers (e.g., that support high-capacity optical communication networks) may use separate pump laser sources for each rail (e.g., for each fiber amplifier), and thus have high power demands. Furthermore, fiber amplifiers, such as O-band amplifiers, may use extensive lengths of active fiber, and are therefore associated with a low power efficiency and a high cost per fiber.

Some implementations described herein relate to a pump system for an optical amplifier that includes a pump laser source and a multicore fiber laser. The pump laser source may be configured to output multimode pump light at a first wavelength (e.g., 915 nanometers (nm)) to the multicore fiber laser. The multicore fiber laser may include an active fiber having multiple active cores. Each of the active cores may include a laser cavity defined by fiber gratings. Thus, the multicore fiber laser can convert the multimode pump light of the pump laser source to multiple single-mode pump lasers at one or more second wavelengths (e.g., 1150 nm). These multiple pump lasers in turn can pump multiple fiber amplifiers (e.g., multiple cores of a multicore active fiber or multiple single-core active fibers) or multiple stages of a fiber amplifier.

By generating multiple pump lasers from a single pump laser source, the pump system reduces the laser power needed to pump multiple fiber amplifiers or to pump multiple stages of a fiber amplifier. Accordingly, the pump system provides a higher power efficiency and a lower cost per fiber. Furthermore, an optical amplifier system that includes the pump system may have reduced complexity by eliminating multiple pump laser sources. For example, the optical amplifier system may include multiple amplifier components that use only a single set of pump components.

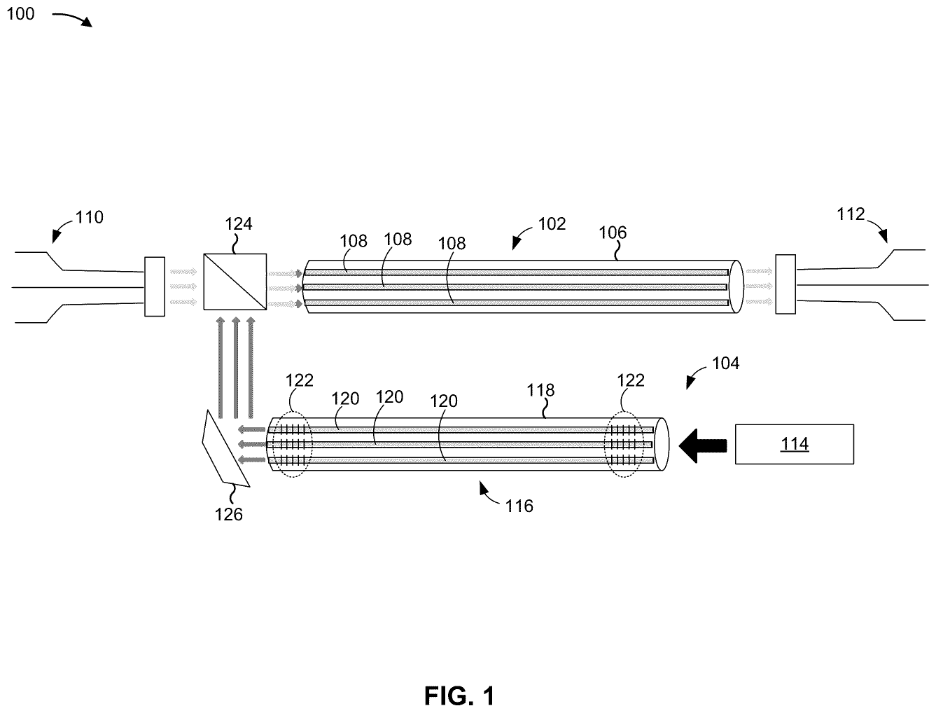

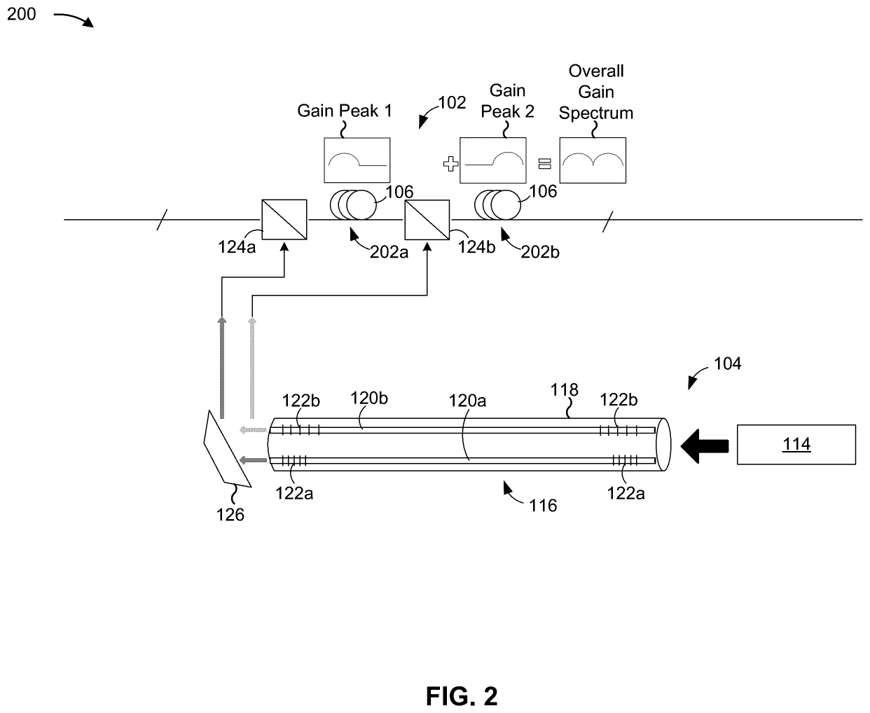

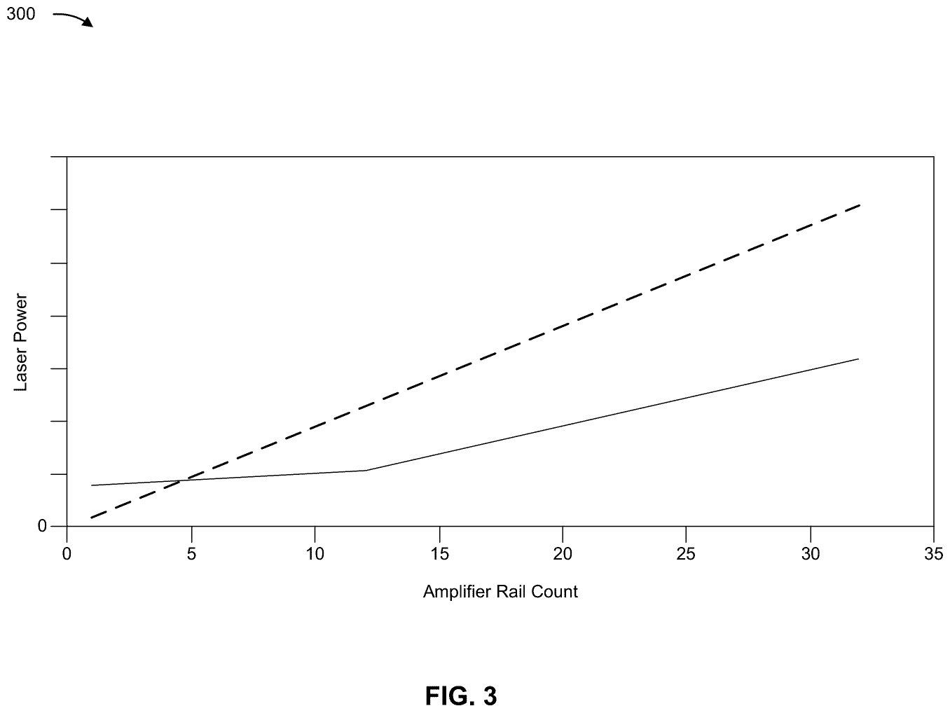

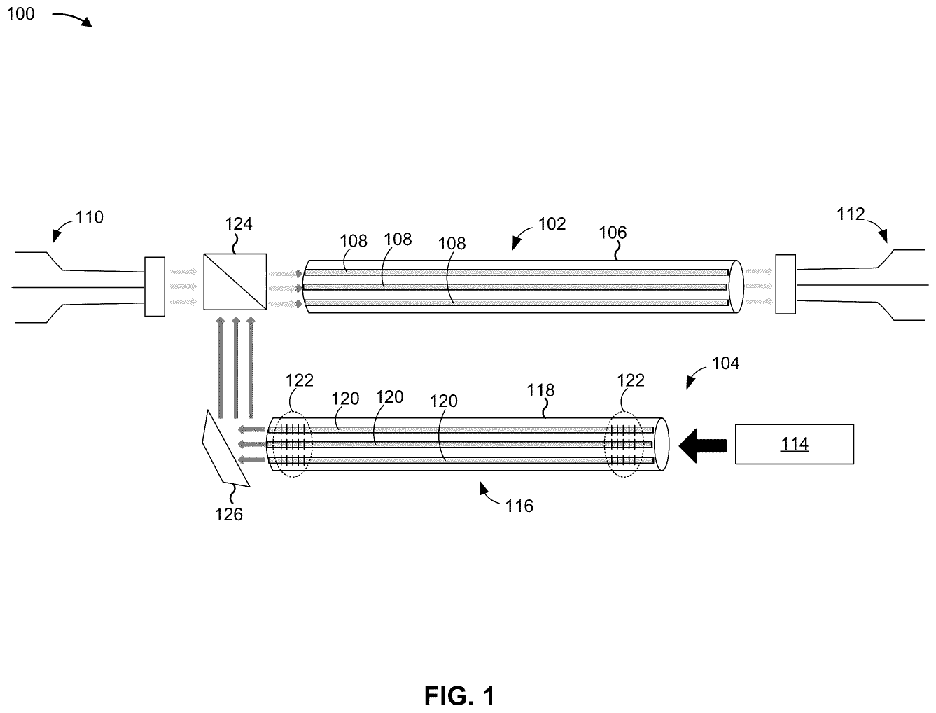

FIG. 1 is a diagram of an example optical system 100. As shown in FIG. 1, the optical system 100 may include an optical amplifier 102 and a pump system 104. For example, the optical system 100 may be an optical amplifier system.

The optical amplifier 102 may provide optical amplification in an optical communication band, such as the O-band. The optical amplifier 102 may include a gain medium that is to be optically pumped to provide optical amplification. The optical amplifier 102 may be a fiber amplifier. In some implementations, the optical amplifier 102 may be another type of optical amplifier that is optically pumped, such as an optical parametric amplifier, or a Raman amplifier, among other examples.

The optical amplifier 102 may include one or more active fibers 106. For example, the optical amplifier 102 may include multiple amplifier components 108 that are in the one or more active fibers 106. As an example, the optical amplifier 102 may include one or more multicore active fibers 106, and/or may include multiple single-core active fibers 106. The active fiber(s) 106 of the optical amplifier 102 may include one or more rare-earth doped fibers (RDFs). For example, the active fiber(s) 106 of the optical amplifier 102 may include one or more bismuth doped fibers (BDFs), which may be suitable for amplification in the O-band.

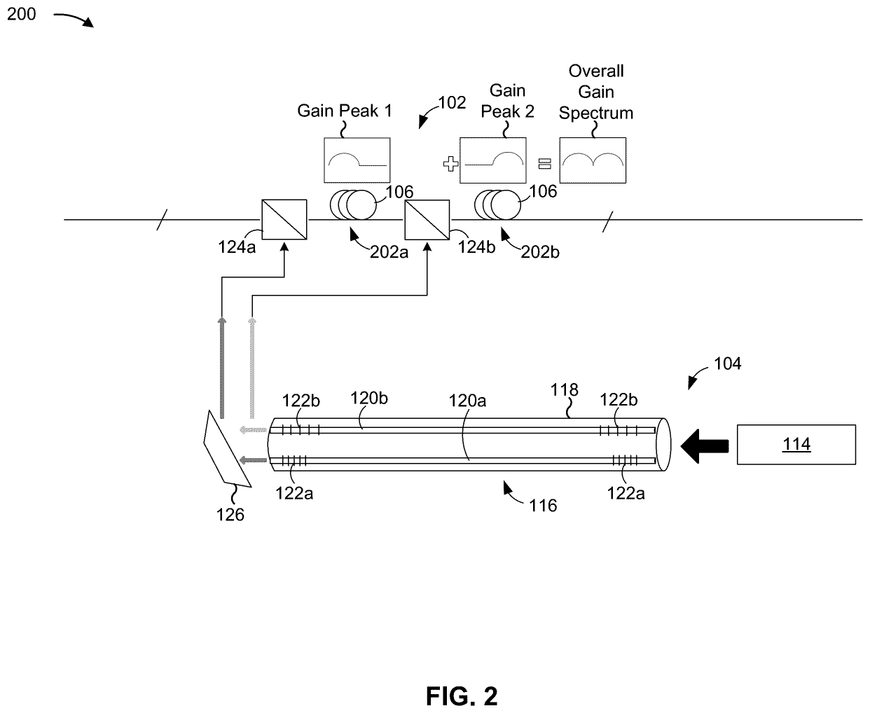

As shown, the multiple amplifier components 108 may include the multiple cores of a multicore active fiber 106 (e.g., each core is an amplifier component 108). For example, the multiple amplifier components 108 may be in a single, multicore active fiber 106. In some implementations, the multiple amplifier components 108 may include multiple single-core active fibers 106 (e.g., each active fiber 106 is an amplifier component 108). For example, the multiple amplifier components 108 may be in multiple single-core active fibers 106 arranged in parallel. As described further in connection with FIG. 2, in some implementations, the multiple amplifier components 108 may include multiple amplifier stages (e.g., each amplifier stage is an amplifier component 108). For example, each amplifier stage may include a single-core active fiber 106 or a multicore active fiber 106.

As shown, an input end of the optical amplifier 102 may be optically coupled to one or more input optical fibers 110 configured to carry signal light (e.g., in the O-band). An output end of the optical amplifier 102 may be optically coupled to one or more output optical fibers 112 configured to carry amplified signal light from the optical amplifier 102. A quantity of input optical fibers 110 and a quantity of output optical fibers 112 may match to a quantity of amplifier rails (e.g., parallel amplification paths) of the optical amplifier 102. For example, as shown in FIG. 1, the optical amplifier 102 has three amplifier rails, and the optical system 100 includes three input optical fibers 110 and three output optical fibers 112.

The pump system 104 is configured to provide optical pumping of the optical amplifier 102. The pump system 104 may include a pump laser source 114 and a multicore fiber laser 116. The pump laser source 114 may be configured to output multimode pump light. The pump laser source 114 may include a laser diode. The laser diode may be edge emitting, vertically emitting, or the like. The laser diode may have a wavelength of 915 nanometers (nm) or another wavelength.

The multicore fiber laser 116 has an input end optically coupled to the pump laser source 114 and an output end optically coupled to the optical amplifier 102. The multicore fiber laser 116 includes a multicore active fiber 118 having multiple fiber cores 120. The multicore active fiber 118 may include an RDF. For example, the multicore active fiber 118 may include an ytterbium doped fiber (YDF), which may provide wavelength(s) for the multicore fiber laser 116 suitable for amplification in the O-band. Accordingly, the multicore active fiber 118 may have a first doping (e.g., has first dopant ions, such as ytterbium ions), and the active fiber(s) 106 of the optical amplifier 102 may have a second doping (e.g., has second dopant ions, such as bismuth ions) different from the first doping. In some implementations, the dopant or co-dopant used in the multicore active fiber 118 may be manipulated to change the wavelength(s) of the multicore fiber laser 116, thereby supporting amplification in optical communication bands other than the O-band.

The pump laser source 114 may be configured to cladding pump the multicore active fiber 118, thereby pumping all of the fiber cores 120 (e.g., the cladding of the multicore active fiber 118 has a geometric shape that causes the pump light to couple into each of the fiber cores 120). In some implementations, the multicore fiber laser 116 may employ multiple single-core active fibers, rather than the multicore active fiber 118, and each of the multiple single-core active fibers may be pumped by a respective single-mode pump laser source. The fiber cores 120 may have respective laser cavities defined by fiber gratings 122 (e.g., fiber Bragg gratings (FBGs)) on each of the fiber cores 120. For example, fiber gratings 122 may be written on individual fiber cores 120. Thus, the multicore active fiber 118 may generate multiple lasers (e.g., where a quantity of lasers corresponds to a quantity of the fiber cores 120). In some implementations, the fiber gratings 122 of two or more fiber cores 120 may have different configurations to produce lasers with different wavelengths, as described further in connection with FIG. 2.

The multimode pump light of the pump laser source 114 may have a first wavelength (e.g., 915 nm), and the multiple fiber cores 120 may be configured to convert the multimode pump light to multiple single-mode pump light outputs at one or more second wavelengths (e.g., 1150 nm). In this way, the multicore fiber laser 116 enables tailoring of an output wavelength of the pump system 104 (e.g., when the pump laser source 114 itself is incapable of producing the output wavelength). Furthermore, the multicore fiber laser 116 creates multiple pump lasers from a single active fiber and from a single pump laser input, thereby improving an efficiency of the optical system 100.

The multicore fiber laser 116 is configured to pump each of the multiple amplifier components 108 of the optical amplifier 102 using a respective pump laser generated by the multicore fiber laser 116. For example, the multiple amplifier components 108 may be pumped by respective fiber cores 120 of the multicore active fiber 118 of the multicore fiber laser 116 (e.g., a quantity of the amplifier components 108 corresponds to a quantity of the fiber cores 120). As an example, the fiber cores 120 may be configured to pump respective active cores of a multicore active fiber 106 of the optical amplifier 102, to pump respective single-core active fibers 106 of the optical amplifier 102, or to pump respective amplifier stages (e.g., to pump active fibers 106 of the respective amplifier stages) of the optical amplifier 102.

The optical system 100 may include a signal combiner 124 optically coupled to the output end of the multicore fiber laser 116 (e.g., directly or indirectly via optics 126, such as a mirror), to the input optical fibers 110, and to the optical amplifier 102 (e.g., which is optically coupled to an output of the signal combiner 124). The signal combiner 124 may be configured to combine the single-mode pump light, output by each of the fiber cores 120 of the multicore fiber laser 116, with the signal light in the input optical fibers 110, and to input the combined light into the optical amplifier 102. In some implementations, the signal combiner 124 is a wavelength division multiplexer (WDM).

While the description above is in terms of an optical amplifier that is optically pumped, in some implementations, the techniques and apparatuses described herein can be applied in connection with optically pumping any optical fiber (e.g., an optical oscillator fiber), optically pumping an optical coupler, or the like.

As indicated above, FIG. 1 is provided as an example. Other examples may differ from what is described with regard to FIG. 1.

FIG. 2 is a diagram of an example optical system 200. As shown in FIG. 2, the optical system 200 may include the optical amplifier 102, the pump system 104, and multiple signal combiners 124. For example, the optical system 200 may be an optical amplifier system. In the optical system 200, the optical amplifier 102 is shown to have multiple amplifier stages 202 in series (shown as a first amplifier stage 202a and a second amplifier stage 202b), and each amplifier stage 202 includes an active fiber 106.

As shown, a first fiber core 120a of the multicore active fiber 118 of the multicore fiber laser 116 may be optically coupled to the first amplifier stage 202a, and a second fiber core 120b may be optically coupled to the second amplifier stage 202b. For example, a first signal combiner 124a may be optically coupled to the first fiber core 120a, to the input optical fibers 110 (not shown in FIG. 2), and to the first amplifier stage 202a (e.g., which is optically coupled to an output of the first signal combiner 124a). The first signal combiner 124a may be configured to combine the pump light, output by the first fiber core 120a, with the signal light in the input optical fibers 110, and to input the combined light into the first amplifier stage 202a. A second signal combiner 124b may be optically coupled to the second fiber core 120b, to an output of the first amplifier stage 202a, and to the second amplifier stage 202b (e.g., which is optically coupled to an output of the second signal combiner 124b). The second signal combiner 124b may be configured to combine the pump light, output by the second fiber core 120b, with the amplified signal light output by the first amplifier stage 202a, and to input the combined light into the second amplifier stage 202b.

In some implementations, the fiber gratings 122 on each of the fiber cores 120 may configure respective wavelengths for the fiber cores 120. For example, the fiber gratings 122 for different fiber cores 120 may have different configurations (e.g., different periodicities) from each other. As shown, the fiber gratings 122a of the first fiber core 120a may have a configuration that is different from a configuration of the fiber gratings 122b of the second fiber core 120b. Accordingly, due to the different configurations of the fiber gratings 122, a pump laser of the first fiber core 120a may have a first wavelength, and a pump laser of the second fiber core 120b may have a second wavelength.

In some implementations, the first wavelength associated with the first fiber core 120a may produce a first gain peak (shown as example Gain Peak 1) in the first amplifier stage 202a. The second wavelength associated with the second fiber core 120b may produce a second gain peak (shown as example Gain Peak 2) in the second amplifier stage 202b that is different from the first gain peak. For example, the first wavelength and the second wavelength may be configured so that the first gain peak and the second gain peak, in combination, produce a flatter overall gain spectrum (shown as Overall Gain Spectrum) relative to the first wavelength alone or the second wavelength alone.

As indicated above, FIG. 2 is provided as an example. Other examples may differ from what is described with regard to FIG. 2.

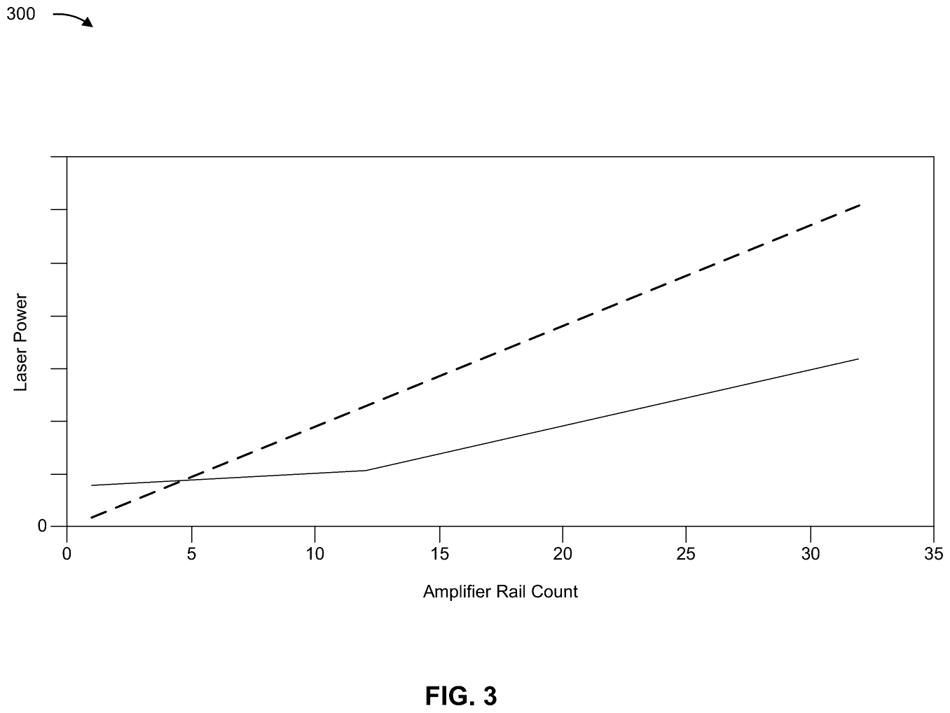

FIG. 3 is a diagram of an example plot 300 showing a relationship between laser power and amplifier rail count. As shown, as the amplifier rail count increases, the laser power needed to produce amplification also increases.

The dashed line represents the relationship between laser power and amplifier rail count for a system that employs an individual pump laser source for each amplifier rail. For example, ten pump laser sources would be used to pump ten amplifier rails. The solid line represents the relationship between laser power and amplifier rail count for an optical system that employs a multicore fiber laser, as described herein. As shown, at higher rail counts, the laser power needed to produce amplification is lower for a system that employs a multicore fiber laser than for a system that employs an individual pump laser source for each amplifier rail.

As indicated above, FIG. 3 is provided as an example. Other examples may differ from what is described with regard to FIG. 3.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical system, comprising:
a pump system comprising:
a pump laser source configured to output multimode pump light at a first wavelength; and
a multicore fiber laser having an input end optically coupled to the pump laser source and an output end, the multicore fiber laser comprising:
a multicore active fiber having multiple cores to convert the multimode pump light to multiple single-mode pump light outputs at one or more second wavelengths,
wherein the multiple cores have respective laser cavities defined by fiber gratings on each of the multiple cores;
a signal combiner, optically coupled to the output end of the multicore fiber laser, configured to combine the single-mode pump light outputs with signal light; and
a fiber amplifier, optically coupled to an output of the signal combiner, comprising multiple amplifier components, in one or more active fibers, that are to be pumped by respective cores, of the multiple cores, of the multicore active fiber.

2. The optical system of claim 1, wherein the fiber gratings on each of the multiple cores configure respective wavelengths for the multiple cores.

3. The optical system of claim 1, wherein the multiple amplifier components comprise multiple cores of a multicore active fiber of the fiber amplifier.

4. The optical system of claim 1, wherein the multiple amplifier components comprise multiple single-core active fibers of the fiber amplifier.

5. The optical system of claim 1, wherein the multiple amplifier components comprise multiple amplifier stages of the fiber amplifier.

6. The optical system of claim 5, wherein the signal combiner is a first signal combiner and the optical system comprises a second signal combiner,
wherein the first signal combiner is optically coupled to a first core, of the multiple cores, and to an input of a first amplifier stage of the multiple amplifier stages, and
wherein the second signal combiner is optically coupled to a second core, of the multiple cores, and to an input of a second amplifier stage, of the multiple amplifier stages, in series with the first amplifier stage.

7. The optical system of claim 6, wherein a first wavelength associated with the first core produces a first gain peak in the first amplifier stage, and
wherein a second wavelength associated with the second core produces a second gain peak in the second amplifier stage that is different from the first gain peak.

8. The optical system of claim 1, wherein the multicore active fiber has a first doping, and
wherein the one or more active fibers have a second doping different from the first doping.

9. The optical system of claim 1, wherein the multicore active fiber is an ytterbium doped fiber.

10. The optical system of claim 1, wherein the one or more active fibers are one or more bismuth doped fibers.

11. The optical system of claim 1, wherein the signal combiner is a wavelength division multiplexer.

12. A pump system, comprising:
a pump laser source configured to output multimode pump light at a first wavelength; and
a multicore fiber laser having an input end optically coupled to the pump laser source and an output end, the multicore fiber laser comprising:
a multicore active fiber having multiple cores to convert the multimode pump light to multiple single-mode pump light outputs at one or more second wavelengths,
wherein the multiple cores have respective laser cavities defined by fiber gratings on each of the multiple cores.

13. The pump system of claim 12, wherein the first wavelength is 950 nanometers, and the one or more second wavelengths include a wavelength of 1150 nanometers.

14. The pump system of claim 12, wherein the multicore active fiber is an ytterbium doped fiber.

15. The pump system of claim 12, wherein the one or more active fibers are one or more bismuth doped fibers.

16. The pump system of claim 12, wherein the fiber gratings on each of the multiple cores configure respective wavelengths for the multiple cores.

17. An optical amplifier system, comprising:
a pump system comprising:
a pump laser source configured to output multimode pump light at a first wavelength; and
a multicore fiber laser having an input end optically coupled to the pump laser source and an output end, the multicore fiber laser comprising:
a multicore active fiber having multiple cores to convert the multimode pump light to multiple single-mode pump light outputs at one or more second wavelengths,
wherein the multiple cores have respective laser cavities defined by fiber gratings on each of the multiple cores; and
a fiber amplifier, optically coupled to the pump system, comprising multiple amplifier components, in one or more active fibers, that are to be pumped by respective cores, of the multiple cores, of the multicore active fiber.

18. The optical amplifier system of claim 17, wherein the multiple amplifier components comprise multiple cores of a multicore active fiber of the fiber amplifier.

19. The optical amplifier system of claim 17, wherein the multiple amplifier components comprise multiple single-core active fibers of the fiber amplifier.

20. The optical amplifier system of claim 17, wherein the multiple amplifier components comprise multiple amplifier stages of the fiber amplifier.
